(19) United States
(12) Patent Application Publication
(10) Pub. No.: US 2022/0234263 A1
(43) Pub. Date: Jul. 28, 2022

(54) Injection Molding Apparatus And Molding Die For Injection Molding

(71) Applicant: Seiko Epson Corporation, Tokyo (JP)

(72) Inventor: Tatsuya TSUBOI, Okaya (JP)

(21) Appl. No.: 17/580,701

(22) Filed: Jan. 21, 2022

(30) Foreign Application Priority Data
Jan. 22, 2021 (JP) 2021-008562

(51) Int. Cl. B29C 45/04; B29C 45/53; B29C 45/64

(52) U.S. Cl. CPC B29C 45/04; B29K 2101/12; B29C 45/64; B29C 45/53

(57) ABSTRACT

The injection molding apparatus includes a fixed mold, a movable mold facing the fixed mold, a mold clamping unit that moves the movable mold with respect to the fixed mold, and an injection unit that injects a molten material into a cavity defined by the fixed mold and the movable mold. At least one of the fixed mold and the movable mold is formed with a flow path communicating with the cavity, and a working fluid that pressurizes and pushes out a molded article in the cavity flows through the flow path.

The present application is based on, and claims priority from JP Application Serial Number 2021-008562, filed Jan. 22, 2021, the disclosure of which is hereby incorporated by reference herein in its entirety.

### BACKGROUND

### 1. Technical Field

The present disclosure relates to an injection molding apparatus and a molding die for injection molding.

### 2. Related Art

JP-A-2020-157635 (PTL 1) discloses an injection molding apparatus including an ejector device for pushing out a molded article from a movable mold. In this injection molding apparatus, the ejector device includes an ejector pin and an ejector motor that is a component that moves the ejector pin. The ejector device is attached to a movable platen. When the ejector motor drives, the ejector pin advances into a cavity, and the molded article is pushed out from the movable mold.

In the injection molding apparatus as described in PTL 1, when a shape of the molded article is changed, it is necessary to change not only the molding die but also the component that moves the ejector pin, and therefore, it takes time and cost to change the shape of the molded article.

### SUMMARY

According to a first aspect of the present disclosure, an injection mold apparatus is provided. The injection molding apparatus includes a fixed mold, a movable mold facing the fixed mold, a mold clamping unit configured to move the movable mold with respect to the fixed mold, and an injection unit configured to inject a molten material into a cavity defined by the fixed mold and the movable mold. At least one of the fixed mold and the movable mold is formed with a flow path communicating with the cavity, and a working fluid that pressurizes and pushes out a molded article in the cavity flows through the flow passage.

According to a second aspect of the present disclosure, a molding die for injection molding is provided. The molding die includes a fixed mold and a movable mold facing the fixed mold and configured to move with respect to the fixed mold. The fixed mold and the movable mold define a cavity to be filled with a molten material. At least one of the fixed mold and the movable mold is formed with a plurality of flow paths communicating with the cavity, and a working fluid that pressurizes and pushes out a molded article in the cavity flows through the plurality of flow paths.

### BRIEF DESCRIPTION OF THE DRAWINGS

FIG. 1 is a front view showing a schematic configuration of an injection molding apparatus according to a first embodiment.

FIG. 2 is a cross-sectional view showing the schematic configuration of the injection molding apparatus according to the first embodiment.

FIG. 3 is a perspective view showing a schematic configuration of a flat screw.

FIG. 4 is a plan view showing a schematic configuration of a barrel.

FIG. 5 is a cross-sectional view showing a schematic configuration of a molding die according to the first embodiment.

FIG. 6 is a plan view showing a schematic configuration of a movable mold according to the first embodiment.

FIG. 7 is a first view showing a state in which a molded article is pushed out.

FIG. 8 is a second view showing a state in which the molded article is pushed out.

FIG. 9 is a third view showing a state in which the molded article is pushed out.

FIG. 10 is a front view showing a schematic configuration of an injection molding apparatus according to a second embodiment.

### DESCRIPTION OF EXEMPLARY EMBODIMENTS

### A. First Embodiment

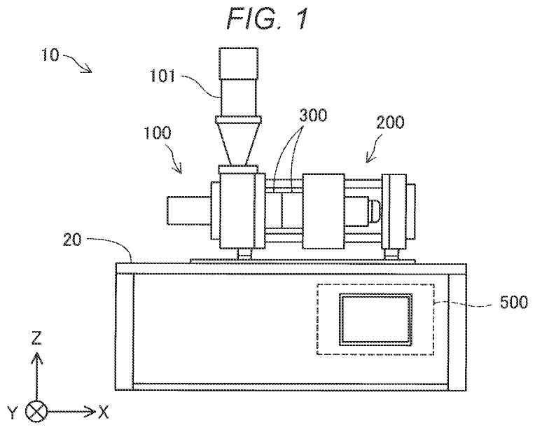

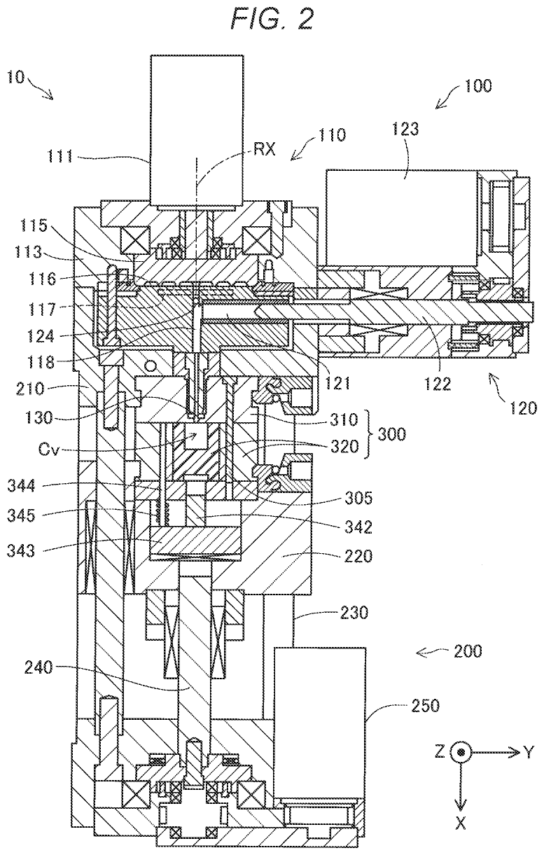

FIG. 1 is a front view showing a schematic configuration of an injection molding apparatus 10 according to a first embodiment. FIG. 1 shows arrows indicating X, Y, and Z directions that are orthogonal. The X direction and the Y direction are directions parallel to a horizontal plane, and the Z direction is a direction opposite to the gravity direction. X, Y, Z directions shown in FIG. 2 and subsequent drawings correspond to the X, Y, Z directions shown in FIG. 1. In the following description, when a direction is specified, indicates a positive direction that is a direction indicated by an arrow, “−” indicates a negative direction that is a direction opposite to the direction indicated by the arrow, and positive and negative symbols are used together to indicate the directions.

The injection molding apparatus 10 includes an injection unit 100, a mold clamping unit 200, a molding die 300, and a control unit 500. In the present embodiment, the injection unit 100, the mold clamping unit 200, and the control unit 500 are fixed to a base 20. The molding die 300 is attached to the mold clamping unit 200.

A hopper 101 into which a molding material, which is a material of a molded article, is fed is coupled to the injection unit 100. As the molding material, for example, a thermoplastic resin formed in a pellet shape is used. The molding material is processed into, for example, a pellet shape.

The injection unit 100 plasticizes at least a part of the molding material supplied from the hopper 101 to generate a molten material, and injects the molten material into the molding die 300. The term “plasticize” means that heat is applied to the molding material having thermoplasticity to melt the molding material. The term “melt” means not only that the molding material having thermoplasticity is heated to a temperature equal to or higher than a melting point to be a liquid, but also means that the molding material having thermoplasticity is softened by being heated to a temperature equal to or higher than a glass transition point and exhibits fluidity. The molten material injected into the molding die 300 is cooled and solidified in the molding die 300 to form a molded article.

The control unit 500 is constituted by a computer including one or a plurality of processors, a main storage device, and an input and output interface that inputs a signal from the outside and outputs a signal to the outside. The control unit 500 controls the injection unit 100 and the mold clamping unit 200 by the processor reading and executing a program on the main storage device to manufacture a molded article.

FIG. 2 is a cross-sectional view showing the schematic configuration of the injection molding apparatus 10. FIG. 2 shows cross sections of the injection unit 100, the mold clamping unit 200, and the molding die 300. The injection unit 100 includes a plasticizing unit 110, an injection control mechanism 120, and a nozzle 130.

The plasticizing unit 110 has a function of plasticizing at least a part of the pellet-shaped molding material supplied from the hopper 101, generating a paste-like molten material having fluidity, and supplying the molten material to the injection control mechanism 120. In the present embodiment, the plasticizing unit 110 includes a screw driving unit 111, a screw case 113, a flat screw 115, a barrel 116, and a plasticizing heater 117.

The screw driving unit 111 includes a motor and a speed reducer. The screw driving unit 111 is driven under the control of the control unit 500. The screw driving unit 111 is coupled to the flat screw 115.

The flat screw 115 is accommodated in a space surrounded by the screw case 113 and the barrel 116. The flat screw 115 accommodated in the space is rotated by a rotational driving force from the screw driving unit 111.

A communication hole 118 penetrating the barrel 116 is provided in a central portion of the barrel 116. An injection cylinder 121, which will be described later, is coupled to the communication hole 118. The communication hole 118 is provided with a check valve 124 upstream of the injection cylinder 121.

The plasticizing heater 117 is embedded in the barrel 116. The plasticizing heater 117 is supplied with electric power and generates heat. A temperature of the plasticizing heater 117 is controlled by the control unit 500.

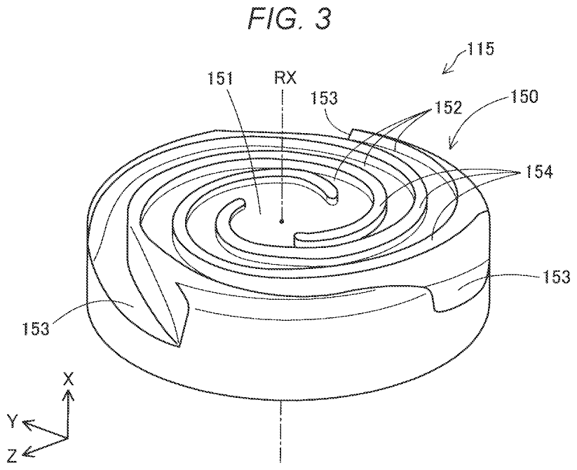

FIG. 3 is a perspective view showing a schematic configuration of the flat screw 115. The flat screw 115 has a substantially columnar shape. A height of the flat screw 115 in a direction along a central axis RX is smaller than a diameter of the flat screw 115. The flat screw 115 has a groove forming surface 150 facing the barrel 116. The groove forming surface 150 is formed with grooves 152 extending spirally around a central portion 151. The grooves 152 communicate with a material inlet 153 formed in a side surface of the flat screw 115. The molding material supplied from the hopper 101 is introduced into the grooves 152 from the material inlet 153. In the present embodiment, three grooves 152 are formed in the groove forming surface 150. The grooves 152 are separated by ridge portions 154. The number of grooves 152 is not limited to three, and may be one, two, four, or more. A shape of the grooves 152 is not limited to a spiral shape, and may be a spiral shape or an involute curve shape, or may be a shape drawing an arc from the central portion 151 toward an outer periphery.

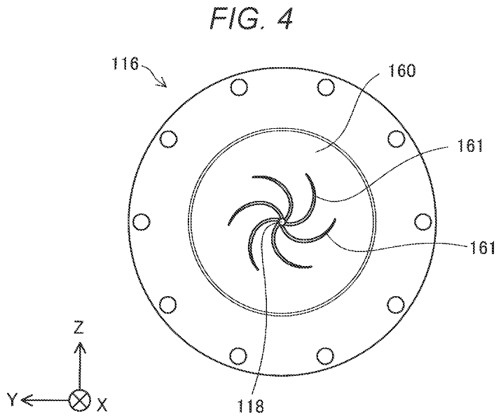

FIG. 4 is a plan view showing a schematic configuration of the barrel 116. The barrel 116 has a facing surface 160 facing the groove forming surface 150 of the flat screw 115. The communication hole 118 is provided at a center of the facing surface 160. The communication hole 118 is provided on an extension line of the central axis RX of the flat screw 115. A plurality of guide grooves 161 coupled to the communication hole 118 and extending in a spiral shape from the communication hole 118 toward the outer periphery are formed in the facing surface 160. The guide grooves 161 provided in the facing surface 160 may not be coupled to the communication hole 118. The guide grooves 161 may not be provided in the facing surface 160.

The molding material supplied to the grooves 152 of the flat screw 115 is plasticized between the flat screw 115 and the barrel 116 by the rotation of the flat screw 115 and the heating from the plasticizing heater 117, flows along the grooves 152 and the guide grooves 161 by the rotation of the flat screw 115, and is guided to the central portion 151 of the flat screw 115. The molten material flowing into the central portion 151 is guided from the communication hole 118 to the injection control mechanism 120.

As shown in FIG. 2, the injection control mechanism 120 includes the injection cylinder 121, a plunger 122, and a plunger drive unit 123. The injection control mechanism 120 has a function of injecting the molten material supplied from the plasticizing unit 110 into the injection cylinder 121 from the nozzle 130. The molten material injected from the nozzle 130 is filled in a cavity Cv of the molding die 300 to be described later.

The injection cylinder 121 is a substantially cylindrical member coupled to the communication hole 118 of the barrel 112, and includes the plunger 122 therein. The plunger 122 slides in the injection cylinder 121 by the plunger drive unit 123 constituted by a motor, and pressure-feeds the molten material in the injection cylinder 121 to the nozzle 130. The plunger drive unit 123 is driven under the control of the control unit 500.

The molding die 300 includes a fixed mold 310 and a movable mold 320 facing the fixed mold 310. When the fixed mold 310 and the movable mold 320 come into contact with each other, the cavity Cv is defined between the fixed mold 310 and the movable mold 320. The cavity Cv is a space having a shape corresponding to the shape of the molded article. The molten material is injected into the cavity Cv from the nozzle 130. The molten material filled in the cavity Cv is cooled and solidified to become the molded article. In the present embodiment, the molding die 300 is provided with a guide pin 305 that prevents positional deviation of the movable mold 320 with respect to the fixed mold 310. The guide pin 305 may not be provided.

The mold clamping unit 200 has a function of moving the movable mold 320 with respect to the fixed mold 310, that is, a function of opening and closing the molding die 300. In the present embodiment, the mold clamping unit 200 includes a fixed platen 210, a movable platen 220, a tie bar 230, a ball screw portion 240, and a mold driving unit 250.

The injection unit 100, the fixed platen 210, and the movable platen 220 are arranged in this order along the X direction. The fixed platen 210 is fixed to a distal end portion of the tie bar 230 provided along the X direction. The fixed mold 310 is fixed to a surface of the fixed platen 210 on a movable platen 220 side by, for example, bolts or clamps.

The movable platen 220 is movable along the tie bar 230. The movable platen 220 is coupled to the ball screw portion 240 provided along the X direction. The movable mold 320 is fixed to the surface of the movable platen 220 on the fixed platen 210 side by, for example, bolts or clamps.

The mold driving unit 250 includes a motor and a speed reducer. The mold driving unit 250 is driven under the control of the control unit 500. The mold driving unit 250 is coupled to the movable mold 320 via the ball screw portion 240. The mold driving unit 250 opens and closes the molding die 300 by rotating the ball screw portion 240 and moving the movable mold 320 fixed to the movable platen 220 with respect to the fixed mold 310 fixed to the fixed platen 210.

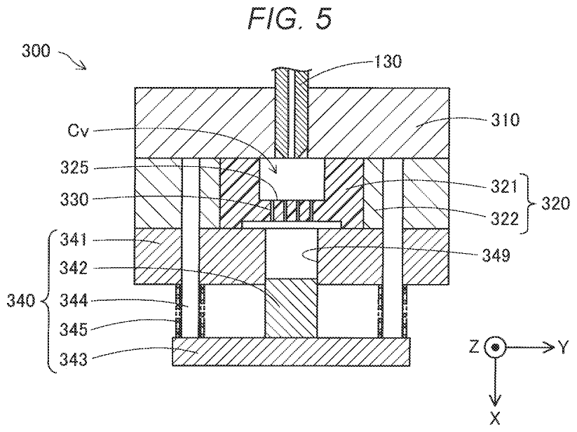

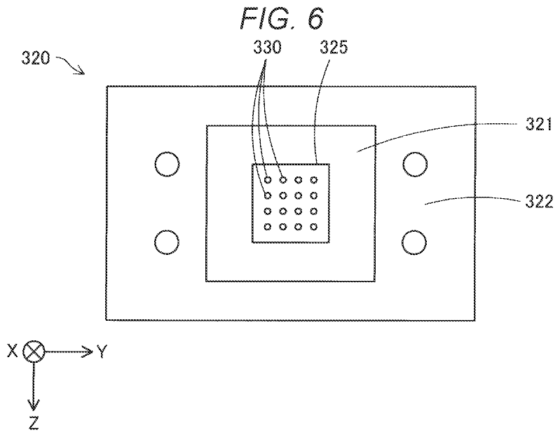

FIG. 5 is a cross-sectional view showing a schematic configuration of the molding die 300. FIG. 6 is a plan view showing a schematic configuration of the movable mold 320. FIG. 5 shows the molding die 300 in a clamped state. In the present embodiment, the molding die 300 includes the fixed mold 310, the movable mold 320, and a pressurizing unit 340.

In the present embodiment, the movable mold 320 includes a nested portion 321 and an accommodating portion 322. The accommodating portion 322 has a cylindrical shape. The nested portion 321 is accommodated inside the accommodating portion 322. The nested portion 321 includes a concave portion 325 on a surface facing the fixed mold 310. When the fixed mold 310 and the nested portion 321 come into contact with each other, the cavity Cv is defined by the fixed mold 310 and the concave portion 325. The fixed mold 310 is provided with a through hole into which the nozzle 130 is inserted, and the molten material is injected into the cavity Cv from the nozzle 130.

The nested portion 321 has a plurality of flow paths 330 communicating with the cavity Cv. In the present embodiment, as shown in FIG. 6, sixteen flow paths 330 are provided in the nested portion 321. As shown in FIG. 5, each flow path 330 penetrates the nested portion 321 along the X direction. The opening shape of each flow path 330 is circular. An opening portion on a cavity Cv side of each flow path 330 has a size capable of preventing the molten material injected into the cavity Cv from flowing into the flow path 330. In the present embodiment, a diameter of the opening portion of each flow path 330 on the cavity Cv side is a few micrometers to hundreds of micrometers. It is preferable that the smaller the viscosity of the molten material injected into the cavity Cv, the smaller the diameter of the opening portion of each flow path 330 on the cavity Cv side. The number of the flow paths 330 is not limited to two or more, and may be one. The opening shape of the flow path 330 may not be circular, and may be, for example, an elliptical shape or a polygonal shape such as a square shape.

In each of the flow paths 330, a working fluid that pressurizes and pushes out the molded article molded in the cavity Cv flows toward the cavity Cv. In the present embodiment, compressed air is used as the working fluid. As the working fluid, a gas other than the compressed air or a liquid such as oil may be used.

The pressurizing unit 340 includes a cylinder portion 341, a piston portion 342, an ejector plate 343, a return pin 344, and a return spring 345. The cylinder portion 341 is disposed on an opposite side of the cavity Cv with respect to the nested portion 321 and the accommodating portion 322. The cylinder portion 341 is fixed to the accommodating portion 322 by, for example, a bolt. The cylinder portion 341 has a cylindrical shape. An internal space of the cylinder portion 341 communicates with the flow path 330 provided in the nested portion 321.

The piston portion 342 is disposed in the internal space of the cylinder portion 341. The piston portion 342 has an outer shape along an inner wall surface 349 of the cylinder portion 341. The piston portion 342 moves relatively with respect to the cylinder portion 341 in the X direction. In the present embodiment, the inner wall surface 349 of the cylinder portion 341 has a cylindrical shape, and the piston portion 342 has a columnar shape. The inner wall surface 349 of the cylinder portion 341 may be formed in a prismatic shape, and the piston portion 342 may be formed in a prismatic shape.

The ejector plate 343 is disposed on an opposite side of the cavity Cv with respect to the cylinder portion 341. The ejector plate 343 is disposed with a gap between the ejector plate 343 and the cylinder portion 341. The piston portion 342 is fixed to a central portion of the ejector plate 343. The return pin 344 is fixed to an outer peripheral portion of the ejector plate 343.

The return pin 344 is a rod-shaped member provided along the X direction. The return pin 344 is inserted through a through hole provided in the cylinder portion 341 and the accommodating portion 322 of the movable mold 320. The ejector plate 343 and the return pin 344 relatively move in the X direction with respect to the cylinder portion 341 together with the piston portion 342.

The return spring 345 is disposed between the cylinder portion 341 and the ejector plate 343. The return spring 345 is a compression coil spring that expands and contracts along the X direction. The return spring 345 is provided along the return pin 344. One end of the return spring 345 is in contact with the cylinder portion 341, and the other end of the return spring 345 is in contact with the ejector plate 343. The return spring 345 pushes back the ejector plate 343 that approached the cylinder portion 341.

In the present embodiment, the fixed mold 310 and the accommodating portion 322 of the movable mold 320 are formed of a metal material. The fixed mold 310 and the accommodating portion 322 are manufactured by performing cutting, electric discharge machining, or the like on a mass of a metal material. As a metal material for forming the fixed mold 310 and the accommodating portion 322, for example, tool steel or stainless steel can be used. The fixed mold 310 may be formed of a resin material or a ceramic material instead of a metal material. The accommodating portion 322 may be formed of a resin material or a ceramic material instead of a metal material.

In the present embodiment, the nested portion 321 of the movable mold 320 is formed of a resin material. The nested portion 321 is manufactured by stacking layers of a resin material using a three-dimensional shaping device. Therefore, the nested portion 321 has a structure in which a plurality of layers are stacked. As the resin material for forming the nested portion 321, for example, a cyclic olefin copolymer (COC), polybenzimidazole (PBI), polyphenylene sulfide (PPS), polyether ether ketone (PEEK), or polyacetal (POM), polyamide (PA66) can be used. When the molding material is a crystalline resin material, the nested portion 321 is preferably formed of a crystalline resin material having a higher melting point than a melting point of the molding material or an amorphous resin material having a higher glass transition point than the melting point of the molding material. When the molding material is an amorphous resin material, the nested portion 321 is preferably formed of a crystalline resin material having a higher melting point than a glass transition point of the molding material or an amorphous resin material having a higher glass transition point than the glass transition point of the molding material. The nested portion 321 may be manufactured without using the three-dimensional shaping device. The nested portion 321 may be formed of a metal material or a ceramic material instead of a resin material. The nested portion 321 and the accommodating portion 322 may be formed of the same material.

In the present embodiment, the cylinder portion 341, the piston portion 342, the ejector plate 343, and the return pin 344 are formed of a metal material. As a metal material for forming the cylinder portion 341, the piston portion 342, the ejector plate 343, and the return pin 344, for example, tool steel or stainless steel can be used. The cylinder portion 341, the piston portion 342, the ejector plate 343, and the return pin 344 may be formed of a resin material or a ceramic material instead of a metal material.

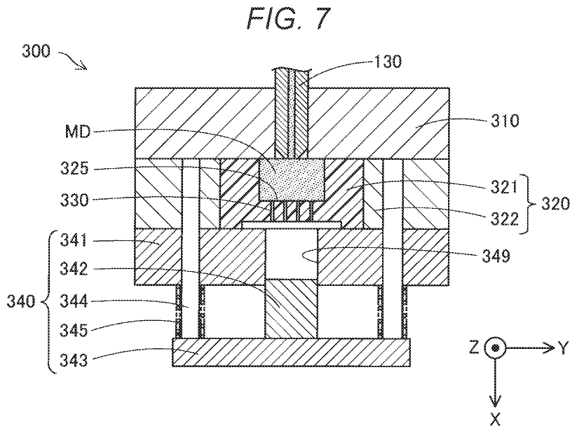

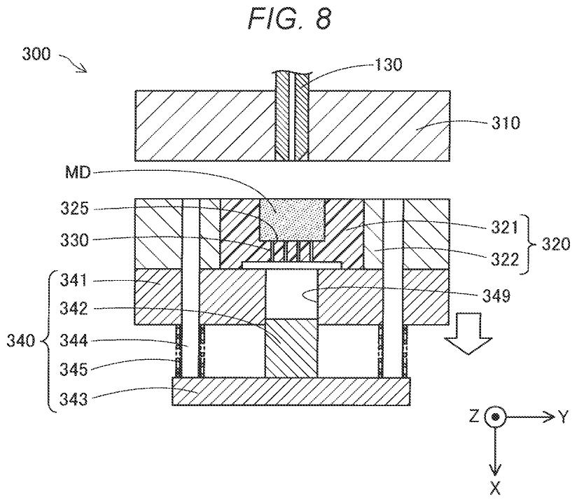

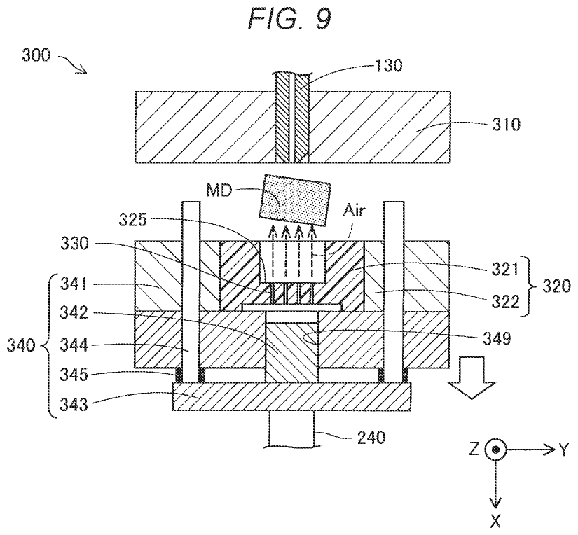

FIG. 7 is a first view showing a state in which a molded article MD is pushed out. FIG. 8 is a second view showing a state in which the molded article MD is pushed out. FIG. 9 is a third view showing a state in which the molded article MD is pushed out.

As shown in FIG. 5, before the molten material is injected into the cavity Cv, the cavity Cv and an inside of the cylinder portion 341 communicate with each other via the flow paths 330. In this state, pressure of the air in the cylinder portion 341 is the same as the atmospheric pressure.

As shown in FIG. 7, when the molten material is injected into the cavity Cv from the nozzle 130, the opening portions on the cavity Cv side of the flow paths 330 are closed by the molten material. Thereafter, the molten material of the cavity Cv is cooled and solidified to become the molded article MD.

As shown in FIG. 8, when the molding die 300 is opened, the movable mold 320 and the cylinder portion 341 move away from the fixed mold 310 by the movement of the movable platen 220 of the mold clamping unit 200. At this time, the piston portion 342, the ejector plate 343, and the return pin 344 are biased by the return spring 345 and move together with the movable mold 320 and the cylinder portion 341.

As shown in FIG. 9, when the ejector plate 343 comes into contact with the distal end portion of the ball screw portion 240, the piston portion 342, the ejector plate 343, and the return pin 344 stop moving. In contrast, the movable mold 320 and the cylinder portion 341 move further away from the fixed mold 310 by the movement of the movable platen 220. Therefore, the piston portion 342 slides on the inner wall surface 349 of the cylinder portion 341. Since the opening portions on the cavity Cv side of the flow paths 330 are closed by the molded article MD, air in the cylinder portion 341 and the flow path 330 is compressed by relative movement of the piston portion 342 with respect to the cylinder portion 341. The molded article MD is pushed toward the fixed mold 310 by the pressure from the compressed air in the flow path 330. When the pressure of the compressed air exceeds a predetermined pressure, the molded article MD is released. The molded article MD that has been released is transported by, for example, a take-out robot installed adjacent to the injection molding apparatus 10.

When the molded article MD is taken out of the concave portion 325, the opening portions on the cavity Cv side of the flow paths 330 are opened, so that the pressure of the air in the flow path 330 and the cylinder portion 341 returns to the same pressure as the atmospheric pressure. When the molding die 300 is clamped again, the piston portion 342, the ejector plate 343 and the return pin 344 are pushed back by the return spring 345 and return to the state shown in FIG. 5.

According to the injection molding apparatus 10 of the present embodiment described above, the molded article MD can be released by being pressurized by the compressed air flowing through the flow path 330 provided in the movable mold 320 without using an ejector pin. When changing the shape of the molded article MD, the molded article MD after change can be molded and released only by changing the movable mold 320 without changing the pressurizing unit 340. Therefore, when the shape of the molded article MD is changed, it is possible to prevent the labor and cost for changing components other than the fixed mold 310 and the movable mold 320. In particular, in the present embodiment, the flow paths 330 are provided in the nested portion 321 having a surface that defines the cavity Cv in the movable mold 320. Therefore, when the shape of the molded article MD is changed, the accommodating portion 322 can be used, so that the material cost for manufacturing the movable mold 320 can be reduced.

In the present embodiment, since the movable mold 320 is provided with the plurality of flow paths 330, it is possible to pressurize a plurality of portions of the molded article MD. Therefore, the molded article MD can be effectively released.

In the present embodiment, the compressed air can be pumped to the flow paths 330 by the relative movement between the cylinder portion 341 and the piston portion 342. Therefore, the molded article MD can be released with a simple configuration. In particular, in the present embodiment, the mold clamping unit 200 moves the movable mold 320, so that the piston portion 342 relatively moves with respect to the cylinder portion 341 fixed to the movable mold 320, and the compressed air is pumped to the flow paths 330. Therefore, the compressed air can be pumped to the flow paths 330 without separately providing a device for relatively moving the piston portion 342 with respect to the cylinder portion 341.

### B. Second Embodiment

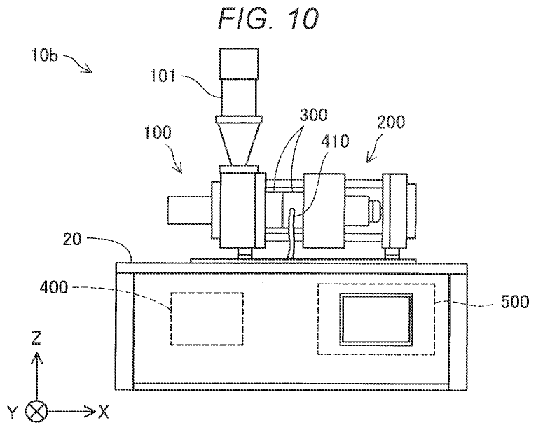

FIG. 10 is a side view showing a schematic configuration of an injection molding apparatus 10b according to a second embodiment. The second embodiment is different from the first embodiment in that the pressurizing unit 340 shown in FIG. 5 is not attached to the movable mold 320 and compressed air is supplied to the flow paths 330 by a pressurizing pump 400. Other configurations are the same as those of the first embodiment unless otherwise specified.

In the present embodiment, the pressurizing pump 400 is coupled to the flow paths 330 via a flexible tube 410. The pressurizing pump 400 is fixed in the base 20. The pressurizing pump 400 is driven under the control of the control unit 500. In the present embodiment, the compressed air is used as a working fluid, and therefore, for example, a centrifugal compressor or a turbo compressor can be used as the pressurizing pump 400. When a liquid such as oil is used as the working fluid, for example, a spiral pump, a gear pump, or a piston pump may be used as the pressurizing pump 400. When the mold is opened, the control unit 500 drives the pressurizing pump 400 to pressure-feed the compressed air to the flow paths 330, thereby releasing the molded article MD molded in the cavity Cv. The pressurizing pump 400 may be referred to as a pressurizing unit.

According to the injection molding apparatus 10b of the present embodiment described above, the compressed air is pressure-fed to the flow paths 330 by the pressurizing pump 400 driven under the control of the control unit 500, and the molded article MD can be released. In particular, in the present embodiment, the control unit 500 can adjust the pressure of the compressed air supplied to the flow paths 330 by adjusting an output of the pressurizing pump 400.

### C. Other Embodiments

(C1) In the injection molding apparatuses 10 and 10b of the above-described embodiments, the flow paths 330 through which the working fluid flows toward the cavity Cv are provided in the movable mold 320. Alternatively, the flow paths 330 may be provided in the fixed mold 310. In this case, for example, the molded article can be pressurized and pushed out by pressure-feeding the working fluid to the flow paths 330 provided in the fixed mold 310 using the pressurizing pump 400 shown in FIG. 10. In addition, the flow paths 330 may be provided in the fixed mold 310 and the movable mold 320. The working fluid can be pressure-fed to the flow paths 330 provided in the fixed mold 310 by using, for example, the pressurizing pump 400. The working fluid can be pressure-fed to the flow paths 330 provided in the movable mold 320 by using, for example, the pressurizing unit 340 or the pressurizing pump 400. By pressure-feeding the working fluid to the flow paths 330 provided in one of the fixed mold 310 and the movable mold 320 to which the molded product is attached, the molded article can be pressurized and pushed out.

(C2) In the injection molding apparatuses 10 and 10b in the above-described embodiments, the pressurizing unit 340 and the pressurizing pump 400 may not be provided in the injection molding apparatuses 10 and 10b. In this case, for example, a pipeline in a factory through which the compressed air flows and the flow paths 330 of the molding die 300 may be coupled via a valve that is opened and closed under the control of the control unit 500, and the compressed air that is the working fluid may be supplied to the flow paths 330 by opening the valve.

(C3) In the injection molding apparatuses 10 and 10b of the embodiments described above, the movable mold 320 has a nested structure in which the movable mold 320 is divided into the nested portion 321 and the accommodating portion 322. In contrast, the movable mold 320 may not have a nested structure. That is, the nested portion 321 and the accommodating portion 322 may be integrated. The nested portion 321, the accommodating portion 322, and the cylinder portion 341 may be integrated, or the nested portion 321 and the accommodating portion 322 may not be integrated, and the accommodating portion 322 and the cylinder portion 341 may be integrated. The fixed mold 310 may have a nested structure.

(C4) In the injection molding apparatuses 10 and 10b of the embodiments described above, the movable mold 320 is manufactured by a three-dimensional shaping device, and has a structure in which a plurality of layers made of a resin material are stacked. In contrast, the movable mold 320 may not have a structure in which a plurality of layers are stacked. The fixed mold 310 may have a structure in which a plurality of layers made of a resin material are stacked by being manufactured by a three-dimensional shaping device.

### D. Other Embodiments

The present disclosure is not limited to the embodiments described above, and can be implemented in various forms without departing from the scope of the present disclosure. For example, the present disclosure can be implemented in the following aspects. In order to solve a part or all of problems of the present disclosure, or to achieve a part or all of effects of the present disclosure, technical features in the above-described embodiments corresponding to technical features in the following aspects can be replaced or combined as appropriate. Unless described as necessary in the present specification, the technical characteristics can be deleted as appropriate.

(1) According to a first aspect of the present disclosure, an injection mold apparatus is provided. The injection molding apparatus includes a fixed mold, a movable mold facing the fixed mold, a mold clamping unit configured to move the movable mold with respect to the fixed mold, and an injection unit configured to inject a molten material into a cavity defined by the fixed mold and the movable mold. At least one of the fixed mold and the movable mold is formed with a flow path communicating with the cavity, and a working fluid that pressurizes and pushes out a molded article in the cavity flows through the flow passage.

According to the injection molding apparatus of this aspect, the molded article can be pressurized and pushed out by the working fluid flowing through the flow path provided in the fixed mold or the working fluid flowing through the flow path provided in the movable mold without using an ejector pin. Therefore, when the shape of the molded article is changed, it is possible to prevent the labor and cost for changing components other than the fixed mold and the movable mold.

(2) In the injection molding apparatus according to the above aspect, a plurality of flow paths may be formed in at least one of the fixed mold and the movable mold.

According to the injection molding apparatus of this aspect, since a plurality of portions of the molded article can be pressurized, the molded article can be effectively pushed out.

(3) The injection molding apparatus according to the above aspect may further include a pressurizing unit configured to pressure-feed the working fluid to the flow path.

According to the injection molding apparatus of this aspect, the molded article can be pushed out by pressure-feeding the working fluid from the pressurizing unit to the flow path.

(4) In the injection molding apparatus according to the aspect described above, the pressurizing unit may include a cylinder portion communicating with the flow path and a piston portion disposed in the cylinder portion, and may pressure-feed the working fluid to the flow path by relative movement of the piston portion with respect to the cylinder portion.

According to the injection molding apparatus of this aspect, the working fluid can be pressure-fed to the flow path by the relative movement between the cylinder portion and the piston portion.

(5) In the injection molding apparatus of the above aspect, the flow path may be formed in the movable mold, and the mold clamping unit may relatively move the piston portion with respect to the cylinder portion by moving the cylinder portion together with the movable mold.

According to the injection molding apparatus of this aspect, the cylinder portion and the piston portion can be relatively moved by the mold clamping unit without separately providing a device for relatively moving the cylinder portion and the piston portion.

(6) In the injection molding apparatus according to the aspect described above, at least one of the fixed mold and the movable mold may include a nested portion that defines the cavity and an accommodating portion that accommodates the nested portion.

According to the injection molding apparatus of this aspect, when shapes of molded articles are made different, components other than the nested portion can be used.

(7) In the injection molding apparatus according to the above aspect, at least one of the fixed mold and the movable mold may have a structure in which a plurality of layers are stacked.

According to the injection molding apparatus of this aspect, a fixed mold or a movable mold in which a plurality of layers are stacked can be manufactured using a three-dimensional shaping device.

(8) According to a second aspect of the present disclosure, a molding die for injection molding is provided. The molding die includes a fixed mold and a movable mold facing the fixed mold and configured to move with respect to the fixed mold. The fixed mold and the movable mold define a cavity to be filled with a molten material. At least one of the fixed mold and the movable mold is formed with a plurality of flow paths communicating with the cavity, and a working fluid that pressurizes and pushes out a molded article in the cavity flows through the plurality of flow paths.

According to the molding die of this aspect, the molded article can be pressurized and pushed out by the working fluid flowing through the flow paths provided in the fixed mold or the working fluid flowing through the flow paths provided in the movable mold without using an ejector pin. Therefore, when the shape of the molded article is changed, it is possible to prevent the labor and cost for changing components other than the fixed mold and the movable mold.

The present disclosure can be implemented in various aspects other than the injection molding apparatus. For example, the present disclosure can be implemented in the form of a molding die for injection molding or the like.

What is claimed is:

1. An injection molding apparatus comprising:
a fixed mold;
a movable mold facing the fixed mold;
a mold clamping unit configured to move the movable mold with respect to the fixed mold; and
an injection unit configured to inject a molten material into a cavity defined by the fixed mold and the movable mold, wherein
at least one of the fixed mold and the movable mold is formed with a flow path communicating with the cavity, and a working fluid that pressurizes and pushes out a molded article in the cavity flows through the flow path.

2. The injection molding apparatus according to claim 1, wherein
a plurality of flow paths are formed in at least one of the fixed mold and the movable mold.

3. The injection molding apparatus according to claim 1, further comprising:
a pressurizing unit configured to pressure-feed the working fluid to the flow path.

4. The injection mold apparatus according to claim 3, wherein
the pressurizing unit includes a cylinder portion communicating with the flow path and a piston portion disposed in the cylinder portion, and pressure-feeds the working fluid to the flow path by relative movement of the piston portion with respect to the cylinder portion.

5. The injection molding apparatus according to claim 4, wherein
the flow path is formed in the movable mold, and
the mold clamping unit moves the piston portion with respect to the cylinder portion by moving the cylinder portion together with the movable mold.

6. The injection molding apparatus according to claim 1, wherein
at least one of the fixed mold and the movable mold includes a nested portion that defines the cavity and an accommodating portion that accommodates the nested portion.

7. The injection molding apparatus according to claim 1, wherein
at least one of the fixed mold and the movable mold has a structure in which a plurality of layers are stacked.

8. A molding die for injection molding, the molding die comprising:
a fixed mold;
a movable mold facing the fixed mold and configured to move with respect to the fixed mold; wherein
the fixed mold and the movable mold define a cavity to be filled with a molten material, and
at least one of the fixed mold and the movable mold is formed with a plurality of flow paths communicating with the cavity, and a working fluid that pressurizes and pushes out a molded article in the cavity flows through the plurality of flow paths.
